(19) United States
(12) Patent Application Publication
(10) Pub. No.: US 2026/0186434 A1
(43) Pub. Date: Jul. 2, 2026

(54) FIXATION SYSTEM AND IMAGE FORMING APPARATUS

(71) Applicant: FUJIFILM Business Innovation Corp., Tokyo (JP)

(72) Inventors: Ayuka NASU, Kanagawa (JP); Ryota HIDAKA, Kanagawa (JP); Keitaro MORI, Kanagawa (JP); Toshiyuki MIYATA, Kanagawa (JP)

(73) Assignee: FUJIFILM Business Innovation Corp., Tokyo (JP)

(21) Appl. No.: 19/293,367

(22) Filed: Aug. 7, 2025

(30) Foreign Application Priority Data
Dec. 27, 2024 (JP) 2024-232977

(51) Int. Cl. G03G 15/20

(52) U.S. Cl. CPC G03G 15/205; G03G 15/2025; G03G 15/2032; G03G 15/2064; G03G 2215/2025

(57) ABSTRACT

A fixation system includes a rotating body; an endless fixation member that forms a holding region where a medium is held between the fixation member and the rotating body in a pressed state where the fixation member is pressed by the rotating body; a heat generator that has a contact region that makes contact with an inner circumference of the fixation member in the holding region with a lubricant containing a thickener interposed therebetween and generates heat in the contact region; and a processor configured to execute a fixation mode in which the fixation member heated by the heat generator rotates in one direction while holding the medium together with the rotating body in the holding region formed in the pressed state to fix an image on the medium and a rotation mode in which the fixation member rotates in the one direction in a relaxed state where the pressed state is relaxed.

### CROSS-REFERENCE TO RELATED APPLICATIONS

This application is based on and claims priority under 35 USC 119 from Japanese Patent Application No. 2024-232977 filed December 27, 2024.

### Background

### (i) Technical Field

The present disclosure relates to a fixation system and an image forming apparatus.

### (ii) Related Art

Japanese Unexamined Patent Application Publication No. 2013-130793 discloses an image heating device that includes a rotatable flexible member, a radiation heat source, a support member, a pressure member, and a pressure applying unit. The radiation heat source is disposed inside the flexible member in a place apart from the flexible member. The support member supports an inner face of the flexible member, and the inner face is a slide face onto which a lubricant is applied. The pressure member forms a nip part together with the support member with the flexible member interposed therebetween. The pressure applying unit applies pressure between the pressure member and the support member. The image heating device heats a recording material passing the nip part. Furthermore, the image heating device includes a pressure relaxing unit and a lubricant displacing unit. The pressure relaxing unit relaxes the pressure applied by the pressure applying unit. In a state where an applied pressure has been relaxed by the pressure relaxing unit, the lubricant displacing unit displaces at least part of a lubricant moved downstream due to the passage of paper together with the flexible member to a place that is upstream of the slide face in the passage of the paper and is not directly irradiated with light from the radiation heat source.

Japanese Unexamined Patent Application Publication No. 2005-317519 discloses a heating device that includes a film, a support member, and a pressure member. The support member has a slide face on which the film slides and supports the film. The pressure member forms a pressure nip part together with the slide face with the film interposed therebetween. The heating device heats a material to be heated while sliding the film on the slide face and transporting the material to be heated that is held between the film and the pressure member in the pressure nip part. Furthermore, the heating device interposes a lubricant containing fluorocarbon resin powder having an average secondary coagulated particle diameter of 10 μm to 30 μm between the slide face and the film.

Japanese Unexamined Patent Application Publication No. 2011-33654 discloses an image heating device that includes a belt member, a drive member, a slide member, and a heating unit for the belt member. A lubricant is applied to an inner face of the belt member. The drive member makes contact with an outer face of the belt member and rotates the belt member. The slide member slides on an inner face of the belt member, and the belt member is interposed between the slide member and the drive member. The image heating device further includes a pressure mechanism and a control unit. The pressure mechanism is capable of changing pressure by which the belt member is held between the drive member and the slide member. The control unit is capable of executing a lubricant movement mode in which the belt member is rotated by the drive member in a state where the pressure by which the belt member is held has been made lower than that during image heating by the pressure mechanism.

### Summary

There may be a fixation system that includes a rotating body, an endless fixation member, a heat generator, and a processor. The endless fixation member forms a holding region where a medium is held between the endless fixation member and the rotating body in a pressed state where the endless fixation member is pressed by the rotating body. The heat generator has a contact region that makes contact with an inner circumference of the fixation member in the holding region with a lubricant containing a thickener interposed therebetween, and generates heat in the contact region.

Furthermore, in the system, the processor may execute only a fixation mode in which the fixation member heated by the heat generator rotates in one direction while holding the medium together with the rotating body in the holding region formed in the pressed state to fix an image on the medium. In this case, for example, in a case where a particle diameter of the thickener contained in the lubricant is large, the lubricant leaking from between the heat generator and the fixation member cannot return to a gap between the heat generator and the fixation member, and the lubricant between the heat generator and the fixation member decreases in the holding region. As a result, defective fixation may occur.

Aspects of non-limiting embodiments of the present disclosure relate to a technique of suppressing occurrence of defective fixation as compared with a case where a processor executes only a fixation mode in which a fixation member heated by a heat generator rotates in one direction while holding a medium together with a rotating body in a holding region formed in a pressed state to fix an image on the medium.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixation system including a rotating body; an endless fixation member that forms a holding region where a medium is held between the fixation member and the rotating body in a pressed state where the fixation member is pressed by the rotating body; a heat generator that has a contact region that makes contact with an inner circumference of the fixation member in the holding region with a lubricant containing a thickener interposed therebetween and generates heat in the contact region; and a processor configured to: execute a fixation mode in which the fixation member heated by the heat generator rotates in one direction while holding the medium together with the rotating body in the holding region formed in the pressed state to fix an image on the medium and a rotation mode in which the fixation member rotates in the one direction in a relaxed state where the pressed state is relaxed.

### Brief Description of the Drawings

An exemplary embodiment of the present disclosure will be described in detail based on the following figures, wherein:

FIG. 1 is a schematic view illustrating an image forming apparatus according to the present exemplary embodiment;

FIG. 2 is a block diagram illustrating a hardware configuration of a controller according to the present exemplary embodiment;

FIG. 3 is a front cross-sectional view illustrating a separated state where a pressure roll is separated from a fixation belt in a fixation system according to the present exemplary embodiment;

FIG. 4 is a front cross-sectional view illustrating a pressed state where the pressure roll is pressed against the fixation belt in the fixation system according to the present exemplary embodiment;

FIG. 5 is a front cross-sectional view illustrating a relaxed state of the pressure roll where the pressed state illustrated in FIG. 4 is relaxed in the fixation system according to the present exemplary embodiment;

FIG. 6 is a schematic view schematically illustrating a part of each of a heater, the fixation belt, and the pressure roll and a thickener of grease in the pressed state of the pressure roll according to the present exemplary embodiment;

FIG. 7 is a schematic view schematically illustrating a part of each of the heater, the fixation belt, and the pressure roll and the thickener of the grease in the relaxed state of the pressure roll according to the present exemplary embodiment;

FIG. 8 is a flowchart illustrating modes executable by the controller according to the present exemplary embodiment; and

FIG. 9 is a flowchart illustrating a case where a grease guide mode is executed by the controller according to the present exemplary embodiment.

### Detailed Description

An exemplary embodiment of the present disclosure is described below with reference to the drawings.

In the drawings, arrow H indicates an up-down direction of the image forming apparatus, arrow W indicates a width direction of the image forming apparatus, and arrow D indicates a depth direction of the image forming apparatus. The up-down direction, the width direction, and the depth direction cross each other (specifically, orthogonal to each other). The +R direction is a counterclockwise rotating direction about the depth direction. The -S direction is a clockwise rotating direction about the depth direction. These directions are directions decided for convenience of description, and therefore the configuration of the image forming apparatus is not limited to these directions. When a direction of the image forming apparatus is mentioned, the word "image forming apparatus" may be omitted. Note that the circled dot symbol in the drawings means an arrow pointing from a far side to a near side of the paper.

A numerical range expressed by using "to" in the present disclosure encompasses numerical values before and after "to" as minimum and maximum values, respectively. In a case where numerical ranges are described in a stepwise manner in the present disclosure, an upper limit value or a lower limit value of one numerical range may be replaced with an upper limit value or a lower limit value of another numerical range.

### Image Forming Apparatus 10

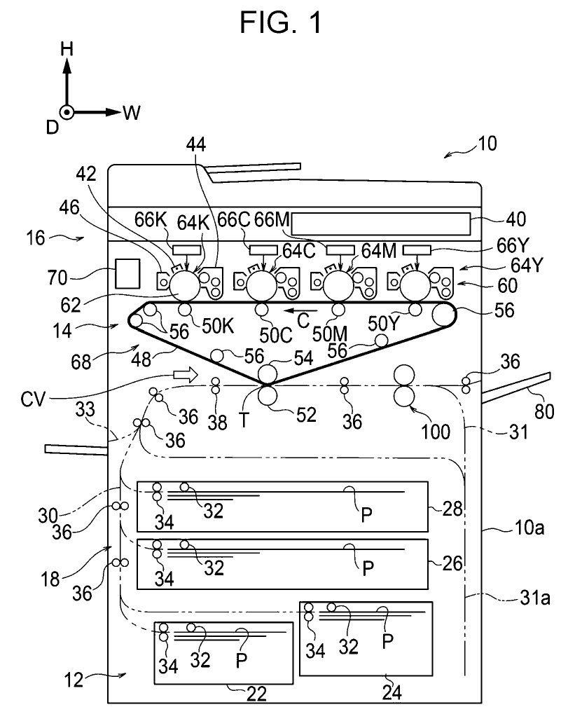

An image forming apparatus 10 forms an image on a sheet member P such as paper. The sheet member P is an example of a medium according to the present disclosure. As illustrated in FIG. 1, in the image forming apparatus 10, each part is disposed inside an apparatus body 10a. The image forming apparatus 10 includes a storage part 12, an operating part 14, a transport part 18, and a controller 70. The image forming apparatus 10 further includes a display part 40 as an interface used by a user to exchange information with the image forming apparatus 10.

### Storage Part 12

The storage part 12 stores the sheet member P therein. The storage part 12 includes a first storage part 22, a second storage part 24, a third storage part 26, and a fourth storage part 28. The sheet members P having different sizes are, for example, stored as appropriate in the first storage part 22, the second storage part 24, the third storage part 26, and the fourth storage part 28. The first storage part 22, the second storage part 24, the third storage part 26, and the fourth storage part 28 each include a feeding roll 32 and a double feed prevention roll 34. The feeding roll 32 feeds the stored sheet members P one by one on the basis of an instruction from the controller 70. The double feed prevention roll 34 transports the sheet members P fed by the feeding roll 32 to a transport path 30 in the image forming apparatus 10 one by one.

Note that although the storage part 12 includes plural storage parts, the storage part according to the present disclosure is not limited to this. The storage part according to the present disclosure may include a single storage part. In a case where the storage part according to the present disclosure includes plural storage parts, the number of storage parts is not limited to four.

### Operating Part 14

The operating part 14 outputs image data sent from a user terminal (not illustrated) or a document reading part 16 to the sheet member P transported from the storage part 12. The operating part 14 includes an image former 60 and a fixation device 100. The image former 60 is an example of an image former according to the present disclosure.

The image former 60 forms a toner image. The toner image is an example of an image according to the present disclosure. The image former 60 includes image forming units 64Y, 64M, 64C, and 64K that form yellow (Y), magenta (M), cyan (C), and black (K) toner images. In the following description, Y, M, C, or K at the end of the reference sign may be omitted in a case where the image forming units 64Y, 64M, 64C, and 64K are not distinguished.

The image forming unit 64 includes a photoconductor drum 62, a charging device 42, a developing device 44, a cleaning member 46, and an exposure device 66 (66Y, 66M, 66C, or 66K). The charging device 42 charges the rotating photoconductor drum 62, and the exposure device 66 forms an electrostatic latent image by irradiating the charged photoconductor drum 62 with exposure light. Furthermore, the developing device 44 develops the electrostatic latent image to visualize the electrostatic latent image as a toner image. That is, the image forming apparatus 10 according to the present exemplary embodiment is an electrophotographic apparatus.

The image former 60 further includes a transfer unit 68. The transfer unit 68 transfers a toner image onto the sheet member P. The transfer unit 68 is located below the image forming units 64Y, 64M, 64C, and 64K. The transfer unit 68 includes a transfer belt 48, a first transfer roll 50, a second transfer roll 52, an auxiliary roll 54, and rolls 56.

The transfer belt 48 is an endless belt and forms an upside-down triangle when viewed from the near side in the depth direction.

The first transfer roll 50 (50K, 50C, 50M, or 50Y) is provided corresponding to the photoconductor drum 62 and holds the transfer belt 48 together with the photoconductor drum 62, and transfers the toner image from the photoconductor drum 62 onto the transfer belt 48.

The second transfer roll 52 is provided below the first transfer roll 50 and transfers a toner image on the transfer belt 48 onto the sheet member P at a transfer position T.

The auxiliary roll 54 is provided on an inner side of the transfer belt 48, that is, provided on a side opposite to the second transfer roll 52 across the transfer belt 48.

The plural rolls 56 are provided on the inner side of the transfer belt 48, and the transfer belt 48 is wound around the rolls 56. At least one of the rolls 56 functions as a drive roll that causes the transfer belt 48 to circulate in the direction indicated by arrow C in FIG. 1.

The fixation device 100 is located downstream of the transfer position T, and fixes, on the sheet member P, a toner image transferred onto the sheet member P. Details of the fixation device 100 will be described later.

### Transport Part 18

The transport part 18 receives the sheet members P transported from the double feed prevention roll 34 or fed from an outside of the apparatus body 10a and transports the sheet members P one by one. The transport part 18 includes the transport path 30, transport rolls 36, and a transport device 38.

The transport path 30 is a path that defines a transport direction of the sheet member P (hereinafter simply referred to as a "transport direction CV").

An upstream portion of the transport path 30 extends upward on one side in the width direction. A manual feeding path 33 is connected to an upper end portion of the upstream portion of the transport path 30.

A downstream portion of the transport path 30 extends from one side to the other side in the width direction and leads to a discharge part 80 that discharges the sheet member P to the outside of the apparatus body 10a. A both-side transport path 31 where the sheet member P is transported and reversed to form an image on a rear surface of the sheet member P is connected to a downstream end portion of the transport path 30. The both-side transport path 31 includes a switchback path 31a, and the sheet member P reversed in the switchback path 31a is fed from the switchback path 31a to the upper end portion of the upstream portion of the transport path 30 in the transport direction CV.

The plural transport rolls 36 are provided along the transport path 30. The transport rolls 36 are provided as pairs in the apparatus body 10a so as to hold the transport path 30.

The transport device 38 is located upstream of the transfer position T in the transport direction CV, and stops the sheet member P once and sends the sheet member P to a second transfer position at a determined timing.

### Controller 70

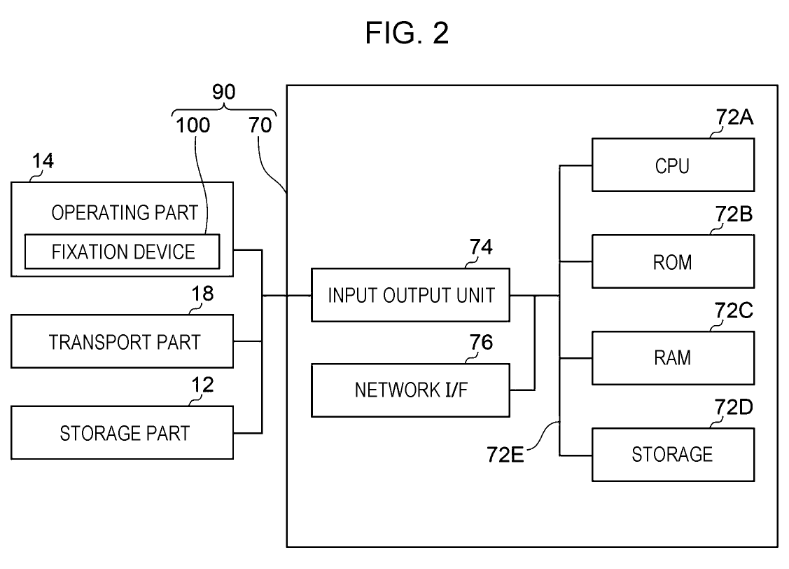

The controller 70 is a computer that controls each part of the image forming apparatus 10. As illustrated in FIG. 2, the controller 70 includes a central processing unit (CPU) 72A, a read only memory (ROM) 72B, a random access memory (RAM) 72C, a storage 72D, an input output unit 74, and a network interface (network I/F) 76. The constituent elements are communicably connected to one another by a bus 72E.

The CPU 72A is a central processing unit, and executes various programs and controls each part. That is, the CPU 72A reads out a program from the ROM 72B or the storage 72D and executes the program while using the RAM 72C as a working area. The CPU 72A is an example of a processor according to the present disclosure. The CPU 72A controls the constituent elements and performs various kinds of arithmetic processing in accordance with a program stored in the ROM 72B or the storage.

The ROM 72B stores various programs and various data therein. The RAM 72C serves as a working area in which a program or data is temporarily stored. The storage 72D is a storage device such as a hard disk drive (HDD) or a solid state drive (SSD), and stores various programs including an operating system and various data therein.

The input output unit 74 receives signals among the constituent elements of the image forming apparatus 10 to accomplish functions of the image forming apparatus 10. For example, the input output unit 74 receives signals among the storage part 12, the operating part 14, and the transport part 18.

The network I/F 76 is an interface for communication with another apparatus and uses, for example, a standard such as Ethernet (Registered Trademark), FDDI, or Wi-Fi (Registered Trademark).

### Details of Fixation Device 100

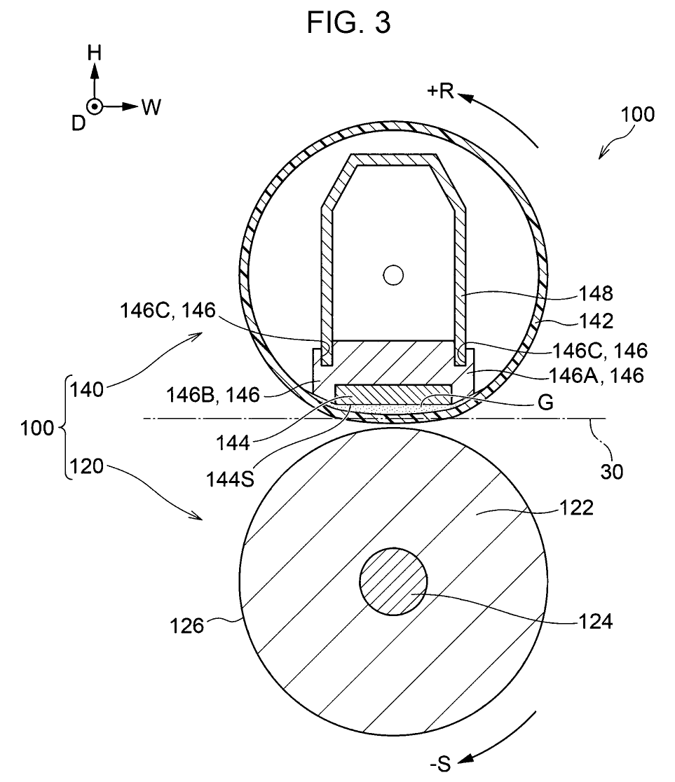

The fixation device 100 is a device that fixes a toner image on the sheet member P. As illustrated in FIGS. 3, 4, and 5, the fixation device 100 includes a pressure roll 120 and a heating part 140.

In the fixation device 100, a toner image is fixed on the sheet member P by the pressure roll 120 and the heating part 140. Specifically, in the fixation device 100, a toner image transferred onto the sheet member P by the image former 60 is fixed on the sheet member P by heating and pressing the sheet member P transported from the transfer position T.

The fixation device 100 constitutes a fixation system 90 together with the controller 70. Note that it may be understood that the fixation device 100 and the CPU 72A in the controller 70 constitute the fixation system 90.

### Pressure Roll 120

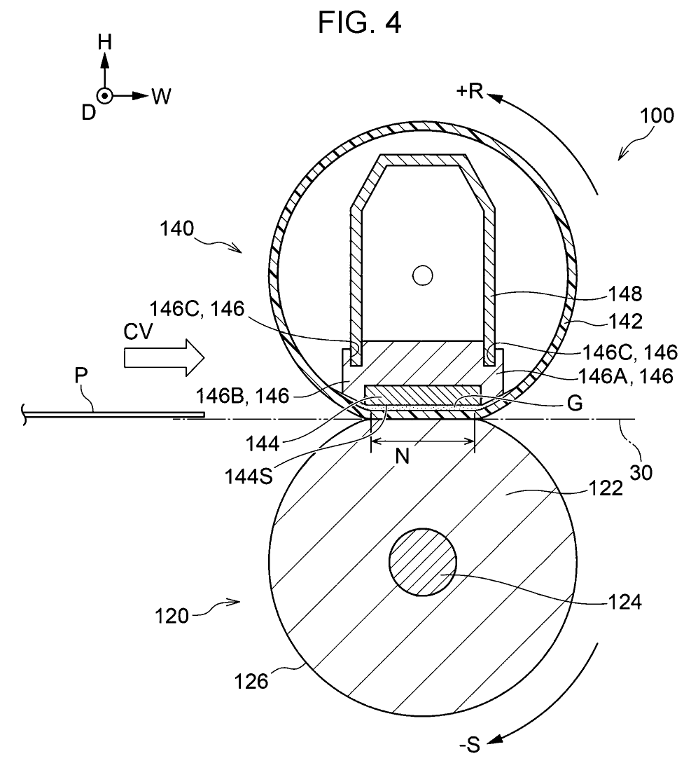

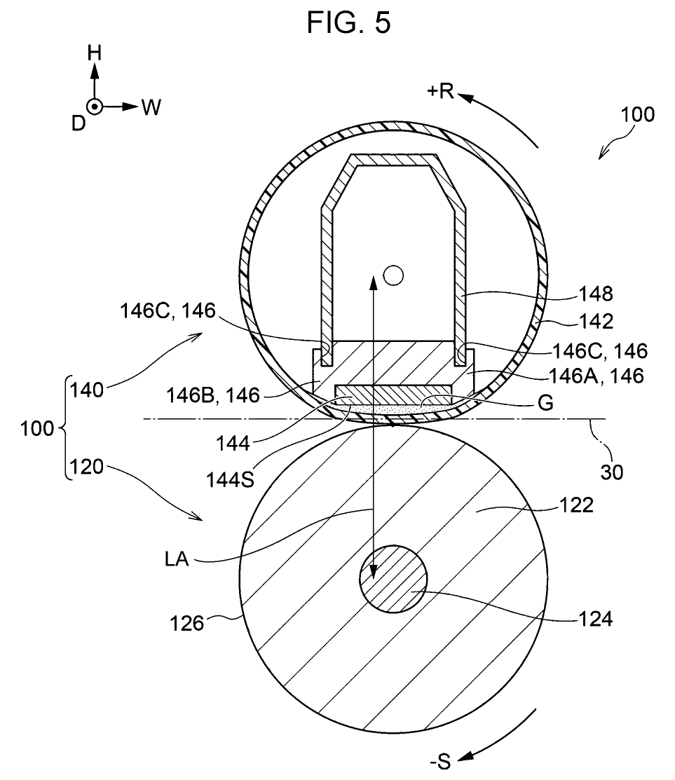

As illustrated in FIGS. 3, 4, and 5, the pressure roll 120 is a roll-shaped member extending in the depth direction. The pressure roll 120 is located below the transport path 30. The pressure roll 120 is rotatably supported on the apparatus body 10a, and is driven by a drive unit (not illustrated) to rotate in the -S direction. The pressure roll 120 is an example of a rotating body according to the present disclosure. The pressure roll 120 is separable from and contactable with a fixation belt 142 by a contact/separation mechanism (not illustrated). The pressure roll 120 is thus switchable among a separated state illustrated in FIG. 3 where the pressure roll 120 is separated from the fixation belt 142, a pressed state illustrated in FIG. 4 where the pressure roll 120 is pressed against the fixation belt 142, and a relaxed state illustrated in FIG. 5 where the pressed state is relaxed.

The pressure roll 120 is, for example, a multilayer structure including a core bar 124, an elastic layer 122, and a release layer 126. The core bar 124 is a thin-walled cylinder made of a steel material and is supported on the apparatus body 10a. The elastic layer 122 is a layer containing silicone rubber or the like coating a surface of the core bar 124. The release layer 126 is a surface layer coating a surface of the elastic layer 122.

### Heating Part 140

As illustrated in FIGS. 3, 4, and 5, the heating part 140 is a structure extending in the depth direction. The heating part 140 is located above the transport path 30. The heating part 140 is configured to melt toner on the sheet member P. The heating part 140 includes the fixation belt 142, a heater 144, a pad 146, and a support member 148. The fixation belt 142 is an example of a fixation member according to the present disclosure. The heater 144 is an example of a heat generator according to the present disclosure.

The fixation belt 142 is an endless belt whose axial direction is the depth direction. The fixation belt 142 has a release layer containing a fluorocarbon resin as needed on an outer circumferential surface of a thin-walled cylindrical base member made of a synthetic resin such as a polyimide resin or a polyamide-imide resin. The fixation belt 142 is rotatably supported on the apparatus body 10a.

The fixation belt 142 has a fixation nip N. The fixation nip N is formed in a case where the pressure roll 120 is in the pressed state illustrated in FIG. 4 where the pressure roll 120 is pressed against the fixation belt 142. The fixation nip N is a region where the sheet member P is held between the fixation belt 142 and the pressure roll 120. The fixation nip N is an example of a holding region according to the present disclosure.

The fixation belt 142 is rotatable in the +R direction in a driven manner following rotation of the pressure roll 120 in a state where the pressure roll 120 is in contact with the fixation belt 142.

The heater 144 is a device that generates heat. Specifically, the heater 144 is a planar heat generator that extends in the depth direction and is provided inside the fixation belt 142. The heater 144 has a contact region 144S that makes contact with an inner circumference of the fixation belt 142 at the fixation nip N with grease G interposed therebetween. A first dimension of the contact region 144S in the +R direction is, for example, larger than a second dimension of the fixation nip N in the +R direction. Note that the first dimension and the second dimension may be identical. The heater 144 includes, for example, a wiring pattern, and generates heat in the contact region 144S when energized on the basis of an instruction from the controller 70.

The grease G is a lubricant that lowers sliding resistance between the fixation belt 142 and the heater 144 when held between the fixation belt 142 and the heater 144. The grease G is smaller in cone penetration than fluorine grease. For example, the grease G is 250 or less in worked penetration defined by JIS K 2220. Furthermore, viscosity of the grease G at 200°C measured by a rheometer is 50 Pa·s to 1500 Pa·s, preferably 80 Pa·s to 1000 Pa·s, more preferably 100 Pa·s to 500 Pa·s. A weight decrease rate of the grease G stored under a heated condition at 230°C for 336 hours is 0 wt% to 20 wt%, preferably 0 wt% to 15 wt%, more preferably 0 wt% to 10 wt%.

The grease G is a combination of base oil and a thickener. The base oil of the grease G is silicone oil and is preferably dimethyl silicone oil, methyl phenyl silicone oil, or diphenyl silicone oil, and a side chain may be partially introduced. A weight-average molecular weight Mw of the silicone oil is 10000 to 100000, preferably 10000 to 60000, more preferably 15000 to 40000.

As a component of the thickener of the grease G, one or more of inorganic materials such as melamine cyanurate, boron nitride, carbon black, silica, graphite, molybdenum disulfide, zinc stearate, and tungsten disulfide are selected. An average particle diameter (D50v) of the thickener is 0.01 μm to 15 μm, preferably 0.1 μm to 10 μm, more preferably 0.1 μm to 5 μm. A weight ratio of the base oil in the components of the grease G is 40 wt% to 95 wt%, preferably 50 wt% to 85 wt%, more preferably 50 wt% to 75 wt%.

The viscosity of the grease G is measured by the following method. A grease sample is held between parallel plates having a diameter of 40 mm, and the viscosity is measured by using a dynamic mechanical analyzer (rheometer ARES-G2 produced by TA instruments) at a gap of 1 mm and an angular velocity of 0.1 rad/s while raising a temperature from 40°C to 200°C at a rate of 6°C/min.

To calculate the weight decrease rate of the grease G, 5 g of the grease sample is collected in an aluminum cup and is heated at 230°C for 336 hours in an oven, and weights before and after the heating are examined.

The average particle diameter of the thickener is measured by the following method. 2 g of the grease sample is collected on filter paper and is filtered under suction after addition of 30 g of tetrahydrofuran (THF) to separate the base oil and the thickener. The separated thickener is dispersed in water, and a particle size distribution is measured by a particle size distribution measurement device (LS13320 produced by Beckman Coulter, Inc.).

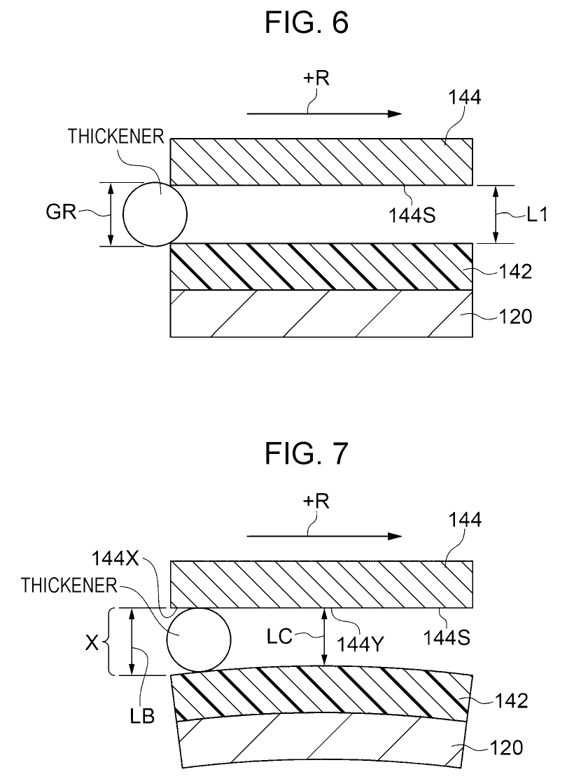

The particle diameter of the thickener of the grease G is larger than a particle diameter of a thickener of fluorine grease. As illustrated in FIG. 6, the particle diameter GR of the thickener of the grease G is larger than a dimension L1 between the contact region 144S and the fixation belt 142 at the fixation nip N in the pressed state of the pressure roll 120 illustrated in FIG. 4. The dimension L1 is, for example, equal to or greater than 3 μm and equal to or less than 10 μm. On the other hand, the particle diameter GR of the thickener of the grease G is, for example, equal to or greater than 20 μm and equal to or less than 50 μm. Accordingly, it is hard for the thickener of the grease G that has leaked from between the contact region 144S of the heater 144 and the fixation belt 142 due to rotation of the fixation belt 142 in the +R direction to return to a gap between the contact region 144S of the heater 144 and the fixation belt 142. The grease G that has leaked from between the contact region 144S of the heater 144 and the fixation belt 142 sometimes forms a pool on an upstream side of the gap between the contact region 144S of the heater 144 and the fixation belt 142 due to rotation of the fixation belt 142. FIG. 6 is a schematic view schematically illustrating a part of each of the heater 144, the fixation belt 142, and the pressure roll 120 and the thickener of the grease G in the pressed state of the pressure roll 120.

The pad 146 is a block-shaped member that extends in the depth direction and is provided inside the fixation belt 142, as illustrated in FIGS. 3 and 4. The pad 146 supports the heater 144 so as to externally cover the heater 144 inside the fixation belt 142. That is, the pad 146 supports the heater 144 by an upstream side of a downstream end portion 146A in the +R direction (in other words, the transport direction CV) and a downstream side of an upstream end portion 146B in the +R direction. The pad 146 is disposed so that the downstream end portion 146A and the upstream end portion 146B make contact with the inner circumferential surface of the fixation belt 142 in a state where the pressure roll 120 is pressed against the fixation belt 142. The pad 146 is supported on the apparatus body 10a. The pad 146 causes an outer circumferential surface of the fixation belt 142 to face an outer circumferential surface of the pressure roll 120. The pad 146 further includes a recessed portion 146C. The recessed portion 146C is a recessed portion on a surface opposite to a support surface for the heater 144.

The support member 148 extends in the depth direction and is provided inside the fixation belt 142, and is a reversed-U-shaped frame when viewed from the depth direction. The support member 148 is supported on the apparatus body 10a. The support member 148 supports the pad 146 at the recessed portion 146C. The support member 148 receives pressing force of the pressure roll 120 via the heater 144 and the pad 146 in the state where the fixation belt 142 is pressed against the pressure roll 120.

### Modes

The controller 70 executes a fixation mode and a grease guide mode in the fixation device 100. The grease guide mode is an example of a rotation mode according to the present disclosure.

### Fixation Mode

The fixation mode is a mode in which a toner image is fixed on the sheet member P. The fixation mode is executed when the image forming apparatus 10 forms an image.

In the fixation mode, the fixation belt 142 heated by the heater 144 rotates in the +R direction while holding the sheet member P at the fixation nip N together with the pressure roll 120 and thus fixes an image on the sheet member P.

In the present exemplary embodiment, specifically, the fixation mode is, for example, executed as follows. The pressure roll 120 is switched to the pressed state illustrated in FIG. 4 to form the fixation nip N. The heater 144 generates heat in the contact region 144S. Then, the pressure roll 120 is driven to rotate in the -S direction. The fixation belt 142 thus rotates in the +R direction in a driven state while holding the sheet member P at the fixation nip N together with the pressure roll 120 and fixes the image on the sheet member P. Note that the +R direction is an example of one direction.

### Grease Guide Mode

The grease guide mode is a mode in which the grease G that has leaked from between the contact region 144S of the heater 144 and the fixation belt 142 is guided into the gap between the contact region 144S of the heater 144 and the fixation belt 142. In the grease guide mode, the fixation belt 142 rotates in the +R direction in the relaxed state where the pressed state of the pressure roll 120 is relaxed.

As described above, the pressure roll 120 is switchable to the relaxed state illustrated in FIG. 5 where the pressed state is relaxed in addition to the separated state illustrated in FIG. 3 and the pressed state illustrated in FIG. 4 by the contact/separation mechanism (not illustrated).

The relaxed state of the pressure roll 120 is a state where pressing of the pressure roll 120 against the fixation belt 142 is relaxed more than the pressed state. A distance LA (see FIG. 5) between an axis of the pressure roll 120 and an axis of the fixation belt 142 in the relaxed state is longer than the distance LA in the pressed state and is shorter than the distance LA in the separated state. Note that a similar relationship is established as for distances between the axis of the pressure roll 120 and the heater 144, the pad 146, and the support member 148.

In the relaxed state, the pressure roll 120 makes contact with the fixation belt 142. Therefore, in the relaxed state of the pressure roll 120, the fixation belt 142 is rotatable in a driven manner following rotation of the pressure roll 120. A contact range between the pressure roll 120 and the fixation belt 142 in the +R direction (in other words, the transport direction) in the relaxed state is shorter than the contact range in the pressed state.

A dimension LB (see FIG. 7) between (hereinafter referred to as a gap X between) an upstream portion 144X of the contact region 144S of the heater 144 in the +R direction and the fixation belt 142 in the relaxed state of the pressure roll 120 is larger than the dimension LB in the pressed state.

In the relaxed state of the pressure roll 120, the dimension LB is larger than a dimension LC (see FIG. 7) between a central portion 144Y of the contact region 144S in the +R direction and the fixation belt 142.

The CPU 72A thus expands the gap X in the grease guide mode. Then, in the grease guide mode, the CPU 72A guides the thickener of the grease G to the enlarged gap X by rotating the fixation belt 142 in the +R direction.

FIG. 7 is a schematic view schematically illustrating a part of each of the heater 144, the fixation belt 142, and the pressure roll 120 and the thickener of the grease G in the relaxed state of the pressure roll 120. Note that specific operation of each part in the grease guide mode will be described later with reference to the flowchart.

### Flowchart

### Mode Determination

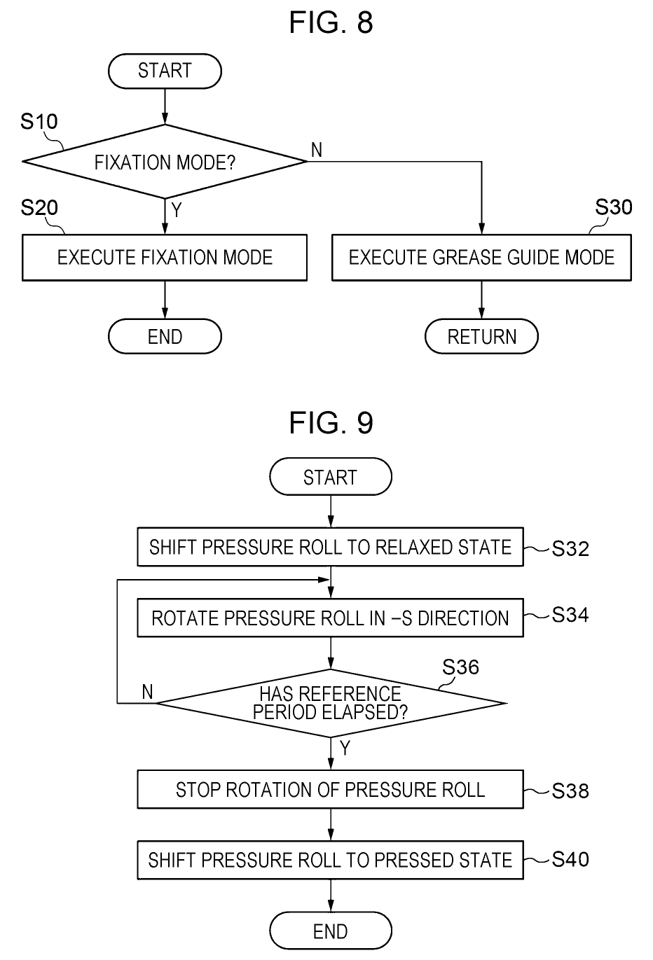

Switching of the mode of the controller 70 is described with reference to FIG. 8. The CPU 72A of the controller 70 determines in step S10 whether or not the fixation mode is maintainable.

For example, in the following cases (1) to (4), it is determined that the fixation mode is not maintainable, and the CPU 72A shifts to the grease guide mode.

(1) case where the number of rotations of the fixation belt 142 (or the pressure roll 120) has reached a predetermined number

(2) case where the number of sheet members P on which an image has been formed by the image forming apparatus 10 has reached a predetermines number

(3) case where a predetermined period has elapsed after image formation of the image forming apparatus 10

(4) case where an instruction is received from a user (not illustrated) of the image forming apparatus 10

In a case where a result of the determination is "Y" meaning Yes, the CPU 72A proceeds to step S20. In step S20, the CPU 72A executes the fixation mode. Then, the CPU 72A ends the flow.

On the other hand, in a case where the result of the determination is "N" meaning No, the CPU 72A proceeds to step S30. In step S30, the CPU 72A executes the grease guide mode. Note that the grease guide mode is executed during a period where the fixation mode is not being executed, specifically, image formation is not being performed by the image forming apparatus 10. For example, the grease guide mode is executed after execution of the fixation mode ends, specifically, after execution of image formation of the image forming apparatus 10 ends. Then, the CPU 72A returns to the start of the flow. In this way, the mode is switched.

Note that the grease guide mode may be executed when the image forming apparatus 10 is powered on.

### Execution of Grease Guide Mode

Next, execution of the grease guide mode in the controller 70 is described with reference to FIG. 9.

When execution of the grease guide mode starts, the CPU 72A of the controller 70 shifts the pressure roll 120 to the relaxed state illustrated in FIG. 5 by actuating the contact/separation mechanism in step S32. This enlarges the dimension LB (see FIG. 7) of the gap X while keeping contact between the pressure roll 120 and the fixation belt 142.

As described above, the dimension LB in the relaxed state of the pressure roll 120 is larger than the dimension LB in the pressed state. Furthermore, as described above, the dimension LB in the relaxed state of the pressure roll 120 is larger than the dimension LC between the central portion 144Y of the heater 144 and the fixation belt 142. Then, the CPU 72A shifts to step S34.

In step S34, the CPU 72A causes the drive unit to rotate the pressure roll 120 in the -S direction. The fixation belt 142 thus rotates in a driven manner in the +R direction. The CPU 72A thus guides the grease G present upstream of the upstream portion 144X in the +R direction into the enlarged gap X. Then, the CPU 72A proceeds to step S36.

In step S36, the CPU 72A determines whether or not a rotation period of the pressure roll 120 has reached a predetermined reference period. In a case where a result of the determination is "Y", the CPU 72A proceeds to step S38.

On the other hand, in a case where the result of the determination is "N", the CPU 72A proceeds to step S34. Then, the CPU 72A continues to rotate the pressure roll 120 in the -S direction until the rotation period of the pressure roll 120 reaches the predetermined reference period.

The reference period is set to a period it takes for the grease G present upstream of the upstream portion 144X in the +R direction to move to the gap X. The reference period is, for example, set to a rotation period it takes for the fixation belt 142 to rotate two times.

In step S38, the CPU 72A stops the rotation of the pressure roll 120. Then, the CPU 72A shifts to step S40.

In step S40, the CPU 72A shifts the pressure roll 120 to the pressed state illustrated in FIG. 4 by actuating the contact/separation mechanism. Thus, the pressure roll 120 is pressed against the fixation belt 142, and the fixation nip N is formed. This expands the grease G guided into the gap X, thereby supplying the grease G to a downstream side in the +R direction. The grease G thus spreads over a wide range between the contact region 144S and the fixation belt 142 within the fixation nip N. Then, the CPU 72A ends the processing.

Note that, for example, the CPU 72A executes the grease guide mode while the heater 144 is stopped. Note that the CPU 72A may executes the grease guide mode while the heater 144 is generating heat.

### Modification of Grease Guide Mode

Although the CPU 72A causes the pressure roll 120 and the fixation belt 142 to be in contact with each other in the grease guide mode in the present exemplary embodiment, this is not restrictive. The CPU 72A may cause the pressure roll 120 and the fixation belt 142 to be apart from each other in the grease guide mode. In this case, for example, a transmission mechanism for transmitting drive force of the pressure roll 120 and a drive source for driving the fixation belt 142 are separately provided.

Although the CPU 72A causes the fixation belt 142 to rotate in a driven manner following rotation of the pressure roll 120 in the relaxed state in the grease guide mode in the present exemplary embodiment, this is not restrictive. For example, the CPU 72A may drive the fixation belt 142 to rotate in the grease guide mode.

Although the CPU 72A makes the dimension LB (see FIG. 7) of the gap X larger than the dimension LC in the relaxed state in the grease guide mode in the present exemplary embodiment, this is not restrictive. For example, the CPU 72A may make the dimension LB of the gap X identical to the dimension LC.

### Other Modifications

Although the present disclosure has been described in detail based on the specific exemplary embodiment, the present disclosure is not limited to the exemplary embodiment, and it is clear to a person skilled in the art that the present disclosure may take other various embodiments within the scope of the present disclosure.

Although the image forming apparatus 10 having the apparatus layout illustrated in FIG. 1 has been described in the above exemplary embodiment, this is not restrictive. For example, the present disclosure is also applicable to an image forming apparatus having an apparatus layout different from the image forming apparatus 10. Although the operating part 14 is a tandem color type in the above exemplary embodiment, this is not restrictive. The operating part may be a rotary type or may be a monochromatic type. Furthermore, the operating part is not limited to an indirect transfer type and may be a direct transfer type.

Although the fixation belt 142 rotates in the +R direction in a driven manner following rotation of the pressure roll 120 in a state where the pressure roll 120 is pressed against the fixation belt 142 in the above exemplary embodiment, this is not restrictive. For example, the pressure roll 120 may rotate in the +R direction in a driven manner following rotation of the fixation belt 142 in a state where the pressure roll 120 is pressed against the fixation belt 142. Alternatively, the fixation belt 142 itself may be driven to rotate.

Although the CPU 72A creates the separated state illustrated in FIG. 3, the pressed state illustrated in FIG. 4, and the relaxed state illustrated in FIG. 5 by moving the pressure roll 120 relative to the fixation belt 142 by the contact/separation mechanism in the above exemplary embodiment, this is not restrictive. For example, the CPU 72A may create the separated state, the pressed state, and the relaxed state by moving the fixation belt 142 instead of or in addition to movement of the pressure roll 120. That is, the CPU 72A may create the separated state, the pressed state, and the relaxed state by moving at least one of the pressure roll 120 and the fixation belt 142 and thereby moving one of the pressure roll 120 and the fixation belt 142 relative to the other one of the pressure roll 120 and the fixation belt 142.

The rotating body according to the present disclosure is not limited to a pressure roll and may be, for example, a pressing member such as a pressure drum. Furthermore, the fixation member according to the present disclosure is not limited to the fixation belt and may be, for example, a fixation member such as a fixation film. Furthermore, the heat generator according to the present disclosure is not limited to a planar heat generator and may be, for example, a heat generator including a lamp or the like having a shape such as a columnar shape or a cylindrical shape.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program of the present application may be provided as a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A fixation system including:

a rotating body;

an endless fixation member that forms a holding region where a medium is held between the fixation member and the rotating body in a pressed state where the fixation member is pressed by the rotating body;

a heat generator that has a contact region that makes contact with an inner circumference of the fixation member in the holding region with a lubricant containing a thickener interposed therebetween and generates heat in the contact region; and

a processor configured to:

execute a fixation mode in which the fixation member heated by the heat generator rotates in one direction while holding the medium together with the rotating body in the holding region formed in the pressed state to fix an image on the medium and a rotation mode in which the fixation member rotates in the one direction in a relaxed state where the pressed state is relaxed.

(((2)))

The fixation system according to (((1))), in which

the processor is configured to bring the rotating body and the fixation member into contact with each other in the relaxed state in the rotation mode.

(((3)))

The fixation system according to (((2))), in which

the processor is configured to rotate the fixation member in a driven manner following rotation of the rotating body in the relaxed state in the rotation mode.

(((4)))

The fixation system according to any one of (((1))) to (((3))), in which

the processor is configured to make a dimension between an upstream portion of the contact region of the heat generator in the one direction and the fixation member in the relaxed state in the rotation mode larger than the dimension in the pressed state.

(((5)))

The fixation system according to (((4))), in which

the processor is configured to, in the rotation mode, guide the lubricant present upstream of the upstream portion in the one direction into a gap between the upstream portion and the fixation member by rotating the fixation member in the one direction.

(((6)))

The fixation system according to any one of (((1))) to (((5))), in which

the processor is configured to, in the relaxed state in the rotation mode, make a dimension between an upstream portion of the contact region of the heat generator in the one direction and the fixation member larger than a dimension between a central portion of the contact region in the one direction and the fixation member.

(((7)))

The fixation system according to (((6))), in which

the processor is configured to, in the rotation mode, guide the lubricant present upstream of the upstream portion in the one direction into a gap between the upstream portion and the fixation member by rotating the fixation member in the one direction.

(((8)))

An image forming apparatus including:

an image former that forms an image on a medium; and

the fixation system according to any one of (((1))) to (((7))) that fixes the image on the medium.

What is claimed is:

1. A fixation system comprising:
a rotating body;
an endless fixation member that forms a holding region where a medium is held between the fixation member and the rotating body in a pressed state where the fixation member is pressed by the rotating body;
a heat generator that has a contact region that makes contact with an inner circumference of the fixation member in the holding region with a lubricant containing a thickener interposed therebetween and generates heat in the contact region; and
a processor configured to:
execute a fixation mode in which the fixation member heated by the heat generator rotates in one direction while holding the medium together with the rotating body in the holding region formed in the pressed state to fix an image on the medium and a rotation mode in which the fixation member rotates in the one direction in a relaxed state where the pressed state is relaxed.

2. The fixation system according to claim 1, wherein
the processor is configured to bring the rotating body and the fixation member into contact with each other in the relaxed state in the rotation mode.

3. The fixation system according to claim 2, wherein
the processor is configured to rotate the fixation member in a driven manner following rotation of the rotating body in the relaxed state in the rotation mode.

4. The fixation system according to claim 1, wherein
the processor is configured to make a dimension between an upstream portion of the contact region of the heat generator in the one direction and the fixation member in the relaxed state in the rotation mode larger than the dimension in the pressed state.

5. The fixation system according to claim 4, wherein
the processor is configured to, in the rotation mode, guide the lubricant present upstream of the upstream portion in the one direction into a gap between the upstream portion and the fixation member by rotating the fixation member in the one direction.

6. The fixation system according to claim 1, wherein
the processor is configured to, in the relaxed state in the rotation mode, make a dimension between an upstream portion of the contact region of the heat generator in the one direction and the fixation member larger than a dimension between a central portion of the contact region in the one direction and the fixation member.

7. The fixation system according to claim 6, wherein
the processor is configured to, in the rotation mode, guide the lubricant present upstream of the upstream portion in the one direction into a gap between the upstream portion and the fixation member by rotating the fixation member in the one direction.

8. An image forming apparatus comprising:
an image former that forms an image on a medium; and
the fixation system according to claim 1 that fixes the image on the medium.

9. An image forming apparatus comprising:
an image former that forms an image on a medium; and
the fixation system according to claim 2 that fixes the image on the medium.

10. An image forming apparatus comprising:
an image former that forms an image on a medium; and
the fixation system according to claim 3 that fixes the image on the medium.

11. An image forming apparatus comprising:
an image former that forms an image on a medium; and
the fixation system according to claim 4 that fixes the image on the medium.

12. An image forming apparatus comprising:
an image former that forms an image on a medium; and
the fixation system according to claim 5 that fixes the image on the medium.

13. An image forming apparatus comprising:
an image former that forms an image on a medium; and
the fixation system according to claim 6 that fixes the image on the medium.

14. An image forming apparatus comprising:
an image former that forms an image on a medium; and
the fixation system according to claim 7 that fixes the image on the medium.

15. A fixation system comprising:
rotating means;
endless fixation means for forming a holding region where a medium is held between the fixation means and the rotating means in a pressed state where the fixation means is pressed by the rotating means;
heat generating means for generating heat in a contact region thereof that makes contact with an inner circumference of the fixation means in the holding region with a lubricant containing a thickener interposed therebetween; and
means for executing a fixation mode in which the fixation means heated by the heat generating means rotates in one direction while holding the medium together with the rotating means in the holding region formed in the pressed state to fix an image on the medium and a rotation mode in which the fixation means rotates in the one direction in a relaxed state where the pressed state is relaxed.
